(19) United States
(12) Patent Application Publication
(10) Pub. No.: US 2025/0246179 A1
(43) Pub. Date: Jul. 31, 2025

(54) INFORMATION PROCESSING SYSTEM, INFORMATION PROCESSING METHOD, AND NON-TRANSITORY RECORDING MEDIUM

(71) Applicant: NEC CORPORATION, Minato-ku, Tokyo (JP)

(72) Inventor: Hitoshi YAMAMOTO, Tokyo (JP)

(73) Assignee: NEC CORPORATION, Minato-ku, Tokyo (JP)

(21) Appl. No.: 18/703,480

(22) PCT Filed: Oct. 28, 2021
(86) PCT No.: PCT/JP2021/039901

§ 371 Date: Apr. 22, 2024

(51) Int. Cl. G10L 15/06; G10L 15/26

(52) U.S. Cl. CPC G10L 15/06; G10L 15/26

(57) ABSTRACT

An information processing system includes: a first text data acquisition unit that acquires first text data: a text data conversion unit that converts the first text data, thereby to generate converted text data; a converted speech data generation unit that generates converted speech data corresponding to the converted text data; and a learning unit that performs learning of a speech recognition unit that generates, from speech data, text data corresponding to the speech data, by using the first text data and the converted speech data as inputs.

### TECHNICAL FIELD

This disclosure relates to technical fields of an information processing system, an information processing apparatus, an information processing method, and a recording medium.

### BACKGROUND ART

A known system of this type performs learning on a speech recognizer. For example, Patent Literature 1 discloses that, in a case where learning/training of a speech recognition apparatus is performed by using speech data and text data, and where the text data do not have the corresponding speech data, the learning is performed by generating pseudo learning data independent of speech recognition.

As another related art, Patent Literature 2 discloses that at least a part of an original speech sentence is ambiguated, thereby to generate a converted speech sentence. Patent Literature 3 discloses that a part of text is replaced with an alternative representation that is the least likely to be subject to voice-quality change of an alternative representation set.

### CITATION LIST

### Patent Literature

Patent Literature 1: JP2014-074732A
Patent Literature 2: JP2017-208003A
Patent Literature 3: International Publication No. WO2007/010680

### SUMMARY

### Technical Problem

This disclosure aims to improve the techniques/technologies disclosed in Citation List.

### Solution to Problem

An information processing system according to an example aspect of this disclosure includes: a first text data acquisition unit that acquires first text data: a text data conversion unit that converts the first text data, thereby to generate converted text data; a converted speech data generation unit that generates converted speech data corresponding to the converted text data; and a learning unit that performs learning of a speech recognition unit that generates, from speech data, text data corresponding to the speech data, by using the first text data and the converted speech data as inputs.

An information processing apparatus according to an example aspect of this disclosure includes: a first text data acquisition unit that acquires first text data: a text data conversion unit that converts the first text data, thereby to generate converted text data; a converted speech data generation unit that generates converted speech data corresponding to the converted text data; and a learning unit that performs learning of a speech recognition unit that generates, from speech data, text data corresponding to the speech data, by using the first text data and the converted speech data as inputs.

An information processing method according to an example aspect of this disclosure is an information processing method executed by at least one computer, the information processing method including: acquiring first text data; converting the first text data, thereby to generate converted text data; generating converted speech data corresponding to the converted text data; and performing learning of a speech recognition unit that generates, from speech data, text data corresponding to the speech data, by using the first text data and the converted speech data as inputs.

A recording medium according to an example aspect of this disclosure is a recording medium on which a computer program that allows at least one computer to execute an information processing method is recorded, the information processing method including: acquiring first text data; converting the first text data, thereby to generate converted text data; generating converted speech data corresponding to the converted text data; and performing learning of a speech recognition unit that generates, from speech data, text data corresponding to the speech data, by using the first text data and the converted speech data as inputs.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a table illustrating an example of first text data and converted text data.

FIG. 4 is a flowchart illustrating a flow of operation by the information processing system according to the first example embodiment.

FIG. 5 is a block diagram illustrating a functional configuration of an information processing system according to a second example embodiment.

FIG. 6 is a flowchart illustrating a flow of operation by the information processing system according to the second example embodiment.

FIG. 7 is a block diagram illustrating a functional configuration of an information processing system according to a third example embodiment.

FIG. 8 is a block diagram illustrating a functional configuration of an information processing system according to a fourth example embodiment.

FIG. 9 is a block diagram illustrating a functional configuration of an information processing system according to a fifth example embodiment.

FIG. 10 is a flowchart illustrating a flow of a conversion learning operation by the information processing system according to the fifth example embodiment.

FIG. 11 is a block diagram illustrating a functional configuration of an information processing system according to a sixth example embodiment.

FIG. 12 is a flowchart illustrating a flow of a conversion learning operation by the information processing system according to the sixth example embodiment.

FIG. 13 is a plan view illustrating a presentation example of second text data by the information processing system according to the sixth example embodiment.

FIG. 14 is a block diagram illustrating a functional configuration of an information processing system according to a seventh example embodiment.

FIG. 15 is a flowchart illustrating a flow of a conversion learning operation by the information processing system according to the seventh example embodiment.

FIG. 16 is a block diagram illustrating a functional configuration of an information processing system according to an eighth example embodiment.

FIG. 17 is a block diagram illustrating a functional configuration of an information processing system according to a ninth example embodiment.

FIG. 18 is a flow chart illustrating a flow of a speech recognition operation by the information processing system according to the ninth example embodiment.

FIG. 19 is a block diagram illustrating a functional configuration of an information processing system according to a tenth example embodiment.

FIG. 20 is a flowchart illustrating a flow of a speech recognition operation by the information processing system according to the tenth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

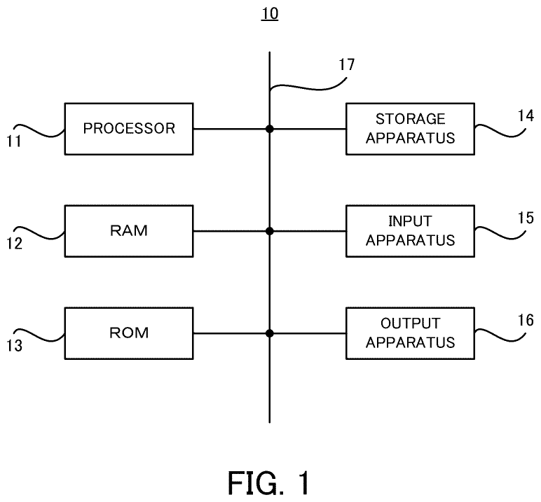

An information processing system according to a first example embodiment will be described with reference to FIG. 1 to FIG. 4.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, the information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing learning/training of a speech recognizer, is realized or implemented in the processor 11. That is, the processor 11 may function as a controller for executing each control of the information processing system 10.

The processor 11 may be configured as, for example, a CPU (Central Processing Unit), a GPU (Graphics Processing Unit), a FPGA (field-programmable gate array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet.

The output apparatus 16 is an apparatus that outputs information about the information processing system10 to the outside. For example, the output apparatus 16 may be a display apparatus (e.g., a display) that is configured to display the information about the information processing system 10. The output apparatus 16 may be a speaker device or the like that is configured to audio-output the information about the information processing system10. The output apparatus 16 may be configured as a portable terminal such as a smartphone and a tablet.

Although FIG. 1 illustrates an example of the information processing system 10 including a plurality of apparatuses, all or a part of the functions thereof may be realized by a single apparatus (information processing apparatus). The information processing apparatus may include only the processor 11, the RAM12, and the ROM13, for example, and an external apparatus connected to the information processing apparatus may include the other components (i.e., the storage apparatus 14, the input apparatus 15, and the output apparatus 16), for example. In the information processing apparatus, a part of an arithmetic function may also be realized by an external apparatus (e.g., an external server or cloud, etc.).

### (Functional Configuration)

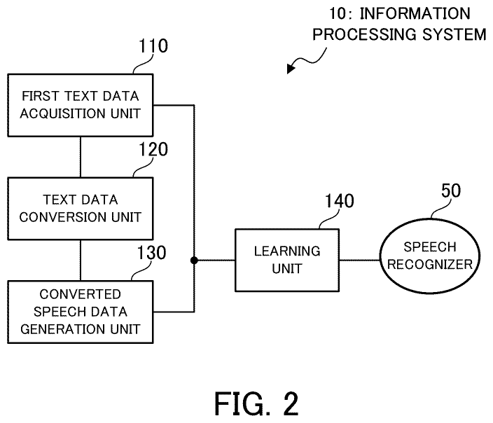

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment is configured to perform learning/training of a speech recognizer 50. The speech recognizer 50 is an apparatus that generates text data from speech data. The learning/training of the speech recognizer 50 is performed so as to generate the text data with higher accuracy, for example. The speech recognizer 50 according to the present example embodiment may have a function of correcting a speech error or a slip of the tongue and converting it into text. The learning of the speech recognizer 50 may be learning/training of a conversion model (i.e., a model for converting the speech data into the text data) used by the speech recognizer 50. The information processing system 10 according to the first example embodiment does not include the speech recognizer 50 itself as a component, but may be configured as a system including the speech recognizer 50.

The information processing system 10 according to the first example embodiment includes, as components for realizing the functions thereof, a first text data acquisition unit 110, a text data conversion unit 120, a converted speech data generation unit 130, and a learning unit 140. Each of the first text data acquisition unit 110, the text data conversion unit 120, the converted speech data generation unit 130, and the learning unit 140 may be, for example, a processing block realized or implemented by the processor 11 (see FIG. 1).

The first text data acquisition unit 110 is configured to acquire first text data. The first text data are text data acquired for the learning of the speech recognizer. The first text data may be, for example, data including only words, or text data in a form of sentences. The first text data acquisition unit 110 may acquire a plurality of first text data. The first text data acquisition unit 110 may acquire the first text data by voice input/voice dictation. That is, the speech data may be converted into text data and acquired as the first text data.

The text data conversion unit 120 is configured to convert the first text data acquired by the first text data acquisition unit 110 and to generate converted text data. The converted text data are text data in which at least a part of the first text data is converted into other letters/characters. The text data conversion unit 120 may generate one piece of converted text data from one piece of first text data, or may generate a plurality of converted text data from one piece of first text data. A specific method of generating the converted text data will be described in detail in another example embodiment described later.

The converted speech data generation unit 130 is configured to generate converted speech data from the converted text data generated by the text data conversion unit 120. That is, the converted speech data generation unit 130 has a function of converting the text data into the speech data. Since a method of converting the text data into the speech data may adopt the existing techniques/technologies as appropriate, a detailed description thereof is omitted here.

The learning unit 140 is configured to perform the learning of the speech recognizer 50 by using the first text data acquired by the first text data acquisition unit 110 and the converted speech data generated by the converted speech data generation unit 130. That is, the learning unit 140 is configured to perform the learning by using a set of the first text data and the converted speech data that correspond to each other. The learning unit 140 may perform the learning by using a plurality of first text data and a plurality of converted speech data.

### (Specific Example of Converted Text Data)

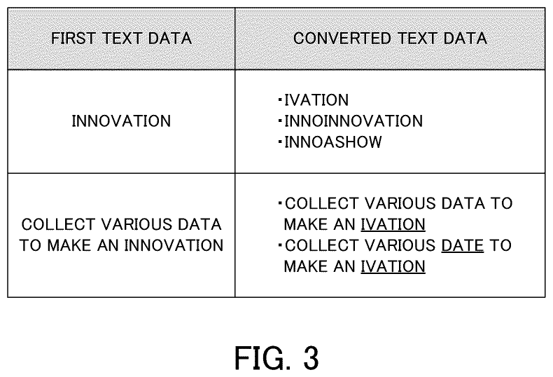

Next, a specific example of the converted text data will be described with reference to FIG. 3. FIG. 3 is a table illustrating an example of the first text data and the converted text data.

As illustrated in FIG. 3, it is assumed that the first text data acquisition unit 110 acquires first text data of “innovation”. In this case, the text data conversion unit 120 may generate converted text data of “ivation,” “innoinnovation,” and “innoashow.” In this way, the text data conversion unit 120 may generate the converted text data, as one that is assumed to be a speech error of the first text data. Although illustrated here is an example of generating three pieces of converted text data from one piece of first text data, one or two pieces of converted text data may be generated, or four or more pieces of converted text data may be generated. Furthermore, although the above example shows a speech error when a speaker is lost for words, the converted text data may be generated on the assumption of other speech errors or the like. For example, the converted text data may be generated on the assumption of a speech error due to a misuse such as “clearing one's honor” and “regaining one's bad reputation”.

In a case where the first text data are in the form of sentences, the text data conversion unit 120 may convert a part of words included in a sentence, thereby to generate the converted text data. In other words, the converted text data may be generated by converting only a part of the words included in the sentence, but not converting the other part. For example, the text data conversion unit 120 may convert only a long word or a katakana word among a plurality of words included in the first text data.

More specifically, for example, in a case where first text data of “collect various data to make an innovation” are acquired, the text data conversion unit 120 may convert only a word of “innovation” in the sentence, thereby to generate converted text data of “collect various data to make an ivation”. The text data conversion unit 120 may convert a plurality of words included in the sentence, thereby to generate converted text. For example, as for the first text data of “collect various data to make an innovation” described above, the text data conversion unit 120 may convert the words of “innovation” and “data”, thereby to generate converted text data of “collect various date to make an ivation”.

In a case where the word included in the context text data is an existing word, the text data conversion unit 120 may exclude the word (i.e., may not output it as the converted text data). For example, in a case where converted text data of “invention” is generated as a result of conversion of the first text data of “innovation”, the word may not be outputted as the converted text data.

### (Flow of Operation)

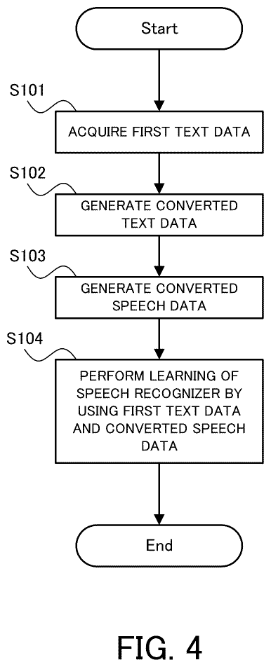

Next, a flow of operation by the information processing system 10 according to the first example embodiment (i.e., an operation in the learning of the speech recognizer 50) will be described with reference to FIG. 4. FIG. 4 is a flowchart illustrating the flow of the operation by the information processing system according to the first example embodiment.

As illustrated in FIG. 4, in operation of the information processing system 10 according to the first example embodiment, first, the first text data acquisition unit 110 acquires the first text data (step S101). The first text data acquired by the first text data acquisition unit 110 are outputted to each of the text data conversion unit 120 and the learning unit 140.

Subsequently, the text data conversion unit 120 converts the first text data acquired by the first text data acquisition unit 110, thereby to generate the converted text data (step S102). The converted text data generated by the text data conversion unit 120 are outputted to the converted speech data generation unit 130.

Subsequently, the converted speech data generation unit 130 generates the converted speech data from the converted text data generated by the text data conversion unit 120 (step S103). The converted speech data generated by the converted speech data generation unit 130 are outputted to the learning unit 140.

Subsequently, the learning unit 140 performs the learning of the speech recognizer 50 by using the first text data acquired by the first text data acquisition unit 110 and the converted speech data generated by the converted speech data generation unit 130 (step S104). A series of processing steps described above may be repeatedly performed at each time when the first text data are acquired.

### (Technical Effect)

Next, a technical effect obtained by the information processing system 10 according to the first example embodiment will be described.

As described in FIG. 1 to FIG. 4, in the information processing system 10 according to the first example embodiment, the learning of the speech recognizer 50 is performed by using the first text data and the converted speech text data as inputs. In this way, the data used for the learning may be augmented by converting the text data, by which it is possible to perform more appropriate learning. For example, in a case where the converted text data are generated on the assumption of the speech error of the first text data, the speech recognizer 50 is allowed to recognize the speech error in the speech data and to generate the text data. Therefore, the speech recognizer 50 is also allowed to generate the text data in which the speech error is automatically corrected.

### Second Example Embodiment

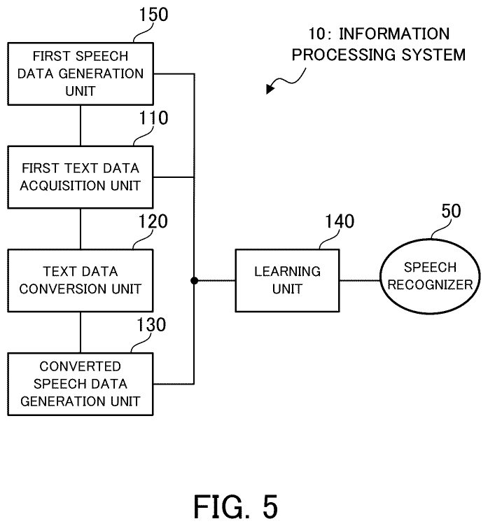

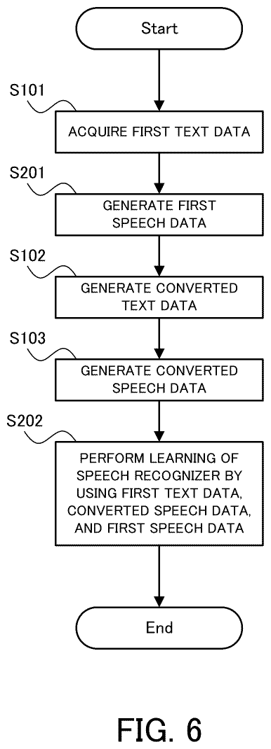

The information processing system 10 according to a second example embodiment will be described with reference to FIG. 5 and FIG. 6. The second example embodiment is partially different from the first example embodiment only in the configuration and operation, and may be the same as the first example embodiment in the other parts. For this reason, a part that is different from the first example embodiment will be described in detail below, and a description of other overlapping parts will be omitted as appropriate.

### (Functional Configuration)

First, a functional configuration of the information processing system 10 according to the second example embodiment will be described with reference to FIG. 5. FIG. 5 is a block diagram illustrating the functional configuration of the information processing system according to the second example embodiment. In FIG. 5, the same components as those illustrated in FIG. 2 carry the same reference numerals.

As illustrated in FIG. 5, the information processing system 10 according to the second example embodiment includes, as components for realizing the functions thereof, the first text data acquisition unit 110, the text data conversion unit 120, the converted speech data generation unit 130, the learning unit 140, and a first speech data generation unit 150. That is, the information processing system 10 according to the second example embodiment further includes the first speech data generation unit 150 in addition to the configuration in the first example embodiment already described (see FIG. 2). The first speech data generation unit 150 may be, for example, a processing block realized or implemented by the processor 11 (see FIG. 1).

The first speech data generation unit 150 is configured first speech data from the first text data acquired by the first text data acquisition unit 110. That is, the first speech data generation unit 150 has a function of converting the text data into the speech data. The first speech data generation unit 150 has the same function as that of the converted speech data generation unit 130 already described. Therefore, the converted speech data generation unit 130 and the first speech data generation unit 150 may be configured as a single common speech data generation unit. In this case, the speech data generation unit may generate and output the converted speech data when the converted text data are inputted, and may generate and output the first speech data when the first text data are inputted.

### (Flow of Operation)

Next, a flow of operation by the information processing system 10 according to the second example embodiment will be described. FIG. 6 is a flowchart illustrating the flow of the operation by the information processing system according to the second example embodiment. In FIG. 6, the same steps as those illustrated in FIG. 4 carry the same reference numerals.

As illustrated in FIG. 6, in operation of the information processing system 10 according to the second example embodiment, first, the first text data acquisition unit 110 acquires the first text data (step S101). The first text data acquired by the first text data acquisition unit 110 are outputted to each of the text data conversion unit 120 and the learning unit 140.

Subsequently, the first speech data generation unit 150 generates the first speech data from the first text data acquired by the first text data acquisition unit 110 (step S201). The first speech data generated by the first speech data generation unit 150 are outputted to the learning unit 140. Although illustrated here is an example in which the first speech data are generated immediately after the first text data are acquired, the first speech data generation unit 150 may generate the first speech data in another timing. For example, the first speech data generation unit 150 may generate the first speech data after the converted text data are generated, or may generate the first speech data after the converted speech data are generated.

Subsequently, the text data conversion unit 120 converts the first text data acquired by the first text data acquisition unit 110, thereby to generate the converted text data (step S102). The converted text data generated by the text data conversion unit 120 are outputted to the converted speech data generation unit 130.

Subsequently, the converted speech data generation unit 130 generates the converted speech data from the converted text data generated by the text data conversion unit 120 (step S103). The converted speech data generated by the converted speech data generation unit 130 are outputted to the learning unit 140.

Subsequently, the learning unit 140 performs the learning of the speech recognizer 50, by using the first text data acquired by the first text data acquisition unit 110, the converted speech data generated by the converted speech data generation unit 130, and the first speech data generated by the first speech data generation unit 150 (step S202). That is, in the second example embodiment, in addition to the first text data and the converted speech data, the first speech data (i.e., the speech data corresponding to the first text data before conversion) are used for the learning of the speech recognizer 50.

### (Technical Effect)

Next, a technical effect obtained by the information processing system 10 according to the second example embodiment will be described.

As described in FIG. 5 and FIG. 6, in the information processing system 10 according to the second exemplary example embodiment, the learning of the speech recognizer 50 is performed by using the first text data, the converted speech data, and the first speech data as inputs. In this way, it is possible to perform the learning of the speech recognizer 50, more properly, in comparison with a case where the first speech data are not used for the learning (i.e., a case where only the first text data and the converted speech data are used for the learning). Specifically, since the learning may be performed in consideration of specifically what type of speech is indicated by text that is included in the first text data, it is possible to realize the speech recognizer 50 with higher accuracy.

### Third Example Embodiment

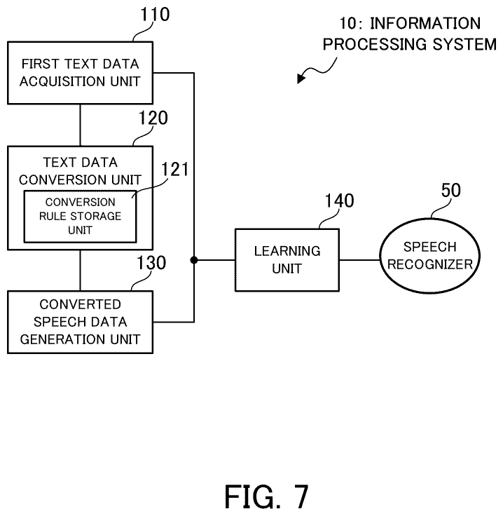

The information processing system 10 according to a third example embodiment will be described with reference to FIG. 7. The third example embodiment is partially different from the first and second example embodiments only in the configuration and operation, and may be the same as the first and second example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the third example embodiment will be described with reference to FIG. 7. FIG. 7 is a block diagram illustrating the functional configuration of the information processing system according to the third example embodiment. In FIG. 7, the same components as those illustrated in FIG. 2 carry the same reference numerals.

As illustrated in FIG. 7, the information processing system 10 according to the third example embodiment includes, as components for realizing the functions thereof, the first text data acquisition unit 110, the text data conversion unit 120, the converted speech data generation unit 130, and the learning unit 140. In particular, the text data conversion unit 120 according to the third example embodiment includes a conversion rule storage unit 121. The conversion rule storage unit 121 may be realized or implemented, for example, by the storage apparatus 14 (see FIG. 1).

The conversion rule storage unit 121 is configured to store a conversion rule for converting the first text data into the converted text data. The text data conversion unit 120 according to the present example embodiment reads the conversion rule stored in the conversion rule storage unit 121 and converts the first text data into the converted text data. The conversion rule storage unit 121 may be one that stores only one conversion rule, or may be one that stores a plurality of conversion rules. In a case where the conversion rule storage unit 121 stores a plurality of conversion rules, the text data conversion unit 120 may select one conversion rule from the plurality of conversion rules, and may generate the converted text data. At this time, the text data conversion unit 120 may select a conversion rule suitable for the first text data to be inputted. Alternatively, the text data conversion unit 120 may generate the converted text data by using each of the plurality of conversion rules. For example, after converting the text data by using a first conversion rule, the text data conversion unit 120 may further convert the text data by using a second conversion rule.

The conversion rule stored in the conversion rule storage unit 121 may be configured to be properly updated (e.g., added, corrected, deleted, etc.). The update of the conversion rule may be performed manually. Alternatively, the update of the conversion rule may be performed mechanically (e.g., by machine learning). The conversion rule storage unit 121 may be configured as an external database of the system. In this case, the text data conversion unit 120 may not include the conversion rule storage unit 121, but may read the conversion rule from the external database of the system, and may generate the converted text data.

### (Specific Examples of Conversion Rule)

Hereinafter, the conversion rule stored in the conversion rule storage unit 121 will be described with some specific examples.

The conversion rule may be “removing a part of letters/characters”. In this case, the first text data of “innovation” may be converted into the converted text data of “ivation”, for example. The conversion rule may be “adding a part of letters/characters”. In this case, the first text data of “innovation” may be converted into converted text data of “innonovation”, for example. The conversion rule may be “changing a part of letters/characters (e.g., replacing it with a similar sound)”. In this case, the first text data of “innovation” may be converted into converted text data of “innoration”, for example. The conversion rule may be “repeating the first few letters/characters”. In this case, the first text data of “innovation” are converted into the converted text data of “innoinnovation”, for example.

In addition, the conversion rule may be a rule based on the assumption of an actual speech error. For example, it is assumed that there are many speech errors of “TOKKYO KYOKYA in Japanese” for a word of “TOKKYO KYOKA in Japanese (meaning patent grant)”. Base on such an example, a conversion rule of “changing vowels or consonants for a word including many consonants of “k” after the “TOKKYO in Japanese (meaning a patent)” may be set, for example. The conversion rule based on such an example may be also learned, for example, by using actual speech data.

The above conversion rule is merely an example, and the conversion rule stored by the conversion rule storage unit 121 is not limited to the above rule.

### (Technical Effect)

Next, a technical effect obtained by the information processing system 10 according to the third example embodiment will be described.

As described in FIG. 7, in the information processing system 10 according to the third example embodiment, the converted text data are generated on the basis of the conversion rule. In this way, it is possible to generate the converted text data, more easily and properly. Furthermore, by updating the conversion rule as appropriate, it is possible to generate more appropriate converted text data, in comparison with a case where the same conversion rule is continuously used.

### Fourth Example Embodiment

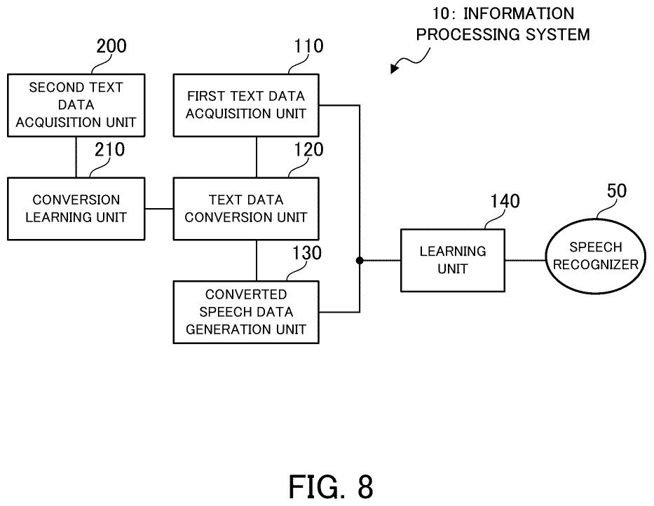

The information processing system 10 according to the fourth example embodiment will be described with reference to FIG. 8. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fourth example embodiment will be described with reference to FIG. 8. FIG. 8 is a block diagram illustrating the functional configuration of the information processing system according to the fourth example embodiment. In FIG. 8, the same components as those illustrated in FIG. 2 carry the same reference numerals.

As illustrated in FIG. 8, the information processing system 10 according to the fourth example embodiment includes, as components for realizing the function thereof, the first text data acquisition unit 110, the text data conversion unit 120, the converted speech data generation unit 130, the learning unit 140, a second text data acquisition unit 200, and a conversion learning unit 210. That is, the information processing system 10 according to the fourth example embodiment further includes the second text data acquisition unit 200 and the conversion learning unit 210, in addition to the configuration in the first example embodiment already described (see FIG. 2). Each of the second text data acquisition unit 200 and the conversion learning unit 210 may be, for example, a processing block realized or implemented by the processor 11 (see FIG. 1).

The second text data acquisition unit 200 is configured to acquire second text data for learning/training of the text data conversion unit 120. The second text data may include, for example, a phrase based on the assumption of the speech error. The second text data acquisition unit 200 may acquire a plurality of second text data. The second text data acquisition unit 200 may acquire the second text data by voice input/voice dictation. That is, the speech data may be converted into the text data and acquired as the second text data.

The conversion learning unit 210 is configured to perform the learning/training of the text data conversion unit 120 by using the second text data acquired by the second text data acquisition unit 200. The learning of the text data conversion unit 120 is performed so as to enable the text data conversion unit 120 to generate more appropriate converted text data from the first text data. The learning/training of the text data conversion unit 120 may be, for example, learning the conversion rule described in the third example embodiment (see FIG. 7). Alternatively, the learning of the text data conversion unit 120 may be machine learning of a generation model that generates the converted text data. A specific learning method by the conversion learning unit 210 will be described in detail in another example embodiment described later.

### (Technical Effect)

Next, a technical effect obtained by the information processing system 10 according to the fourth example embodiment will be described.

As described in FIG. 8, in the information processing system 10 according to the fourth example embodiment, the learning of the text data conversion unit 120 is performed by using the second text data. In this way, it is possible to perform the learning of the text data conversion unit 120, easily and properly. Furthermore, by performing the learning of the text data conversion unit 120, it is possible to generate more appropriate converted text data from the first text data.

### Fifth Example Embodiment

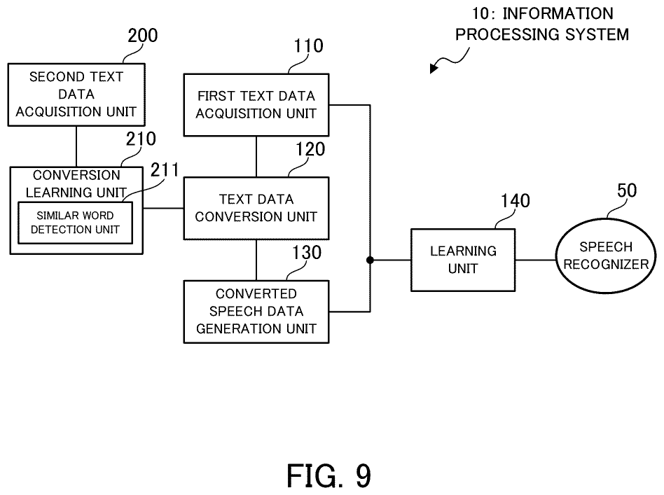

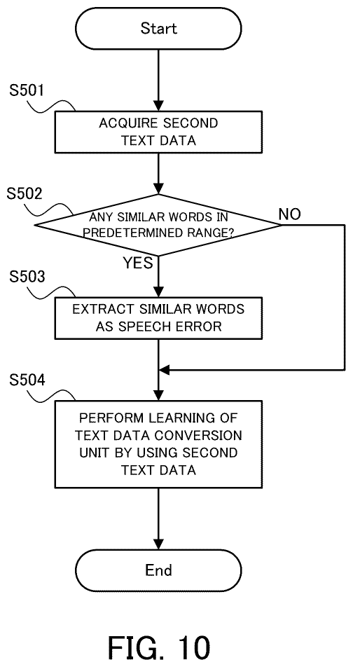

The information processing system 10 according to a fifth example embodiment will be described with reference to FIG. 9 and FIG. 10. The fifth example embodiment is partially different from the fourth example embodiment only in the configuration and operation, and may be the same as the first to fourth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fifth example embodiment will be described with reference to FIG. 9. FIG. 9 is a block diagram illustrating the functional configuration of the information processing system according to the fifth example embodiment. In FIG. 9, the same components as those illustrated in FIG. 8 carry the same reference numerals.

As illustrated in FIG. 9, the information processing system 10 according to the fifth example embodiment includes, as components for realizing the function thereof, the first text data acquisition unit 110, the text data conversion unit 120, the converted speech data generation unit 130, the learning unit 140, the second text data acquisition unit 200, and the conversion learning unit 210. In particular, the conversion learning unit 210 according to the fifth example embodiment includes a similar word detection unit 211.

The similar word detection unit 211 is configured to detect whether or not similar words are included in the second text data. More specifically, the similar word detection unit 211 is configured to detect whether a first word and a second word, which are similar to each other, are included in a predetermined range of the second text data. Here, the “predetermined range” corresponds to a period until the user who has made a speech error corrects the speech error (specifically, corrects it to a correct word), and may be set to have an appropriate value in advance. The predetermined range may be, for example, a range that is set for the number of letters/characters of the text data. For example, the similar word detection unit 211 may determine whether or not there are similar words in a range of 20 letters/characters. The predetermined range may be changeable by the user. For example, in a case where the similar words are excessively detected, the predetermined range may be changed to be small (e.g., 20 letters/characters may be changed to 15 letters/characters). Conversely, in a case where the similar words are hardly detected, the predetermined range may be changed to be large (e.g., 20 letters/characters may be changed to 30 letters/characters). Here, the similar words are, for example, words that are different from each other only by one or a few letters/characters, or words that have at least one same consonant, but have different vowels.

The similar word detection unit 211 may calculate a degree of similarity of each of words included in the second text data, and may detect the first word and the second word that are similar to each other. For example, the similar word detection unit 211 extracts the words included in the second text data, and calculates the degree of similarity of each extracted word. Note that a method of calculating the degree of similarity may properly adopt the existing technologies/techniques. In a case where it is determined that there is a set of words in which the degree of similarity is higher than a predetermined threshold, the similar word detection unit 211 detects those words as the first word and the second word. The predetermined threshold is a threshold that is set in advance to determine whether or not the words are similar. The predetermined threshold may be changeable by the user. For example, in a case where the similar words are excessively detected, the predetermined threshold may be changed to be large. Conversely, in a case where the similar words are hardly detected, the predetermined threshold may be changed to be small. The similar word detection unit 211 may detect the similar words (i.e., the first word and the second word) in a method other than the above method.

### (Conversion Learning Operation)

Next, a flow of an operation of performing the learning of the text data conversion unit 120 (hereinafter referred to as a “conversion learning operation” as appropriate) in the information processing system 10 according to the fifth example embodiment will be described with reference to FIG. 10. FIG. 10 is a flowchart illustrating the flow of the conversion learning operation by the information processing system according to the fifth example embodiment.

As illustrated in FIG. 10, when the conversion learning operation of the information processing system 10 according to the fifth example embodiment is started, first, the second text data acquisition unit 200 acquires the second text data (step S501). The second text data acquired by the second text data acquisition unit 200 are outputted to the conversion learning unit 210.

Subsequently, the similar word detection unit 211 in the conversion learning unit 210 determines whether or not there are similar words in a predetermined range of the second text data (step S502). When there are similar words in the predetermined range (the step S502: YES), the similar word detection unit 211 detects those words as the first word and the second word (step S503).

For example, in a case where the second text data include a sentence of “We . . . to make an invation, to make an innovation”, the similar word detection unit 211 may detect “invation” and “innovation” as the first word and the second word, respectively. As described above, in a case where a speaker has made a speech error, the speaker who notices the speech error is likely to correct the speech error immediately after that. The similar word detection unit 211 may detect such a misspoken word and a corrected word, as the first word and the second word, respectively.

The similar word detection unit 211 may also detect a plurality of sets of the first word and the second word from the second text data. For example, in a case where the second text data include a sentence of “We collet various date, data, to make an invation, to make an innovation”, the similar word detection unit 211 may detect “invation” and “innovation” as the first word and the second word, respectively, and may detect “date” and “data” as the first word and the second word, respectively.

In addition to the first word and the second word, the similar word detection unit 211 may detect a third word that is similar to them. For example, in a case where the second text data include a sentence of “We . . . to make an invation, to make an innoinnovation, to make an innovation”, the similar word detector 211 may detect “invation,” “innoinnovation,” and “innovation”, as the first word, the second word, and the third word, respectively. As described above, in a case where there are three or more similar words, all of them may be detected as the similar words. That is, the words detected by the similar word detection unit 211 are not limited to two words that are the first word and the second word.

When there are no similar words in the predetermined range (the step S502: NO), the similar word detection unit 211 may not detect the first word and the second word (i.e., the step S503 may be omitted).

Subsequently, the conversion learning unit 210 performs the learning of the text data conversion unit 120 by using the second text data (step S504). Especially in a case where the first word and the second word are detected in the step S503, the conversion learning unit 210 performs the learning of the text data conversion unit 120 on the assumption that one of the first word and the second word is a speech error of the other. For example, in a case where “invation” and “innovation” are detected as the first word and the second word, the conversion learning unit 210 performs the learning of the text data conversion unit 120 on the assumption that “invation” is a speech error of “innovation”. Furthermore, in a case where three or more similar words are detected, all those words may be considered to perform the learning. For example, in a case where the first word, the second word, and the third word are detected, the learning of the text data conversion unit 120 may be performed by using the first word and the second word as misspoken words, and the third word as a corrected word. In a case where the first word and the second word are not detected, the conversion learning unit 210 may perform the learning of the text data conversion unit 120 without consideration of the presence of the first word and the second word.

### (Technical Effect)

Next, a technical effect obtained by the information processing system 10 according to the fifth example embodiment will be described.

As described in FIG. 9 and FIG. 10, in the information processing system 10 according to the fifth example embodiment, the first word and the second word that are similar to each other are detected to perform the learning of the text data conversion unit 120. In this way, it is possible to take into account the misspoken word and the corrected word thereof, and it is thus possible to perform the learning of the text data conversion unit 120, more properly.

### Sixth Example Embodiment

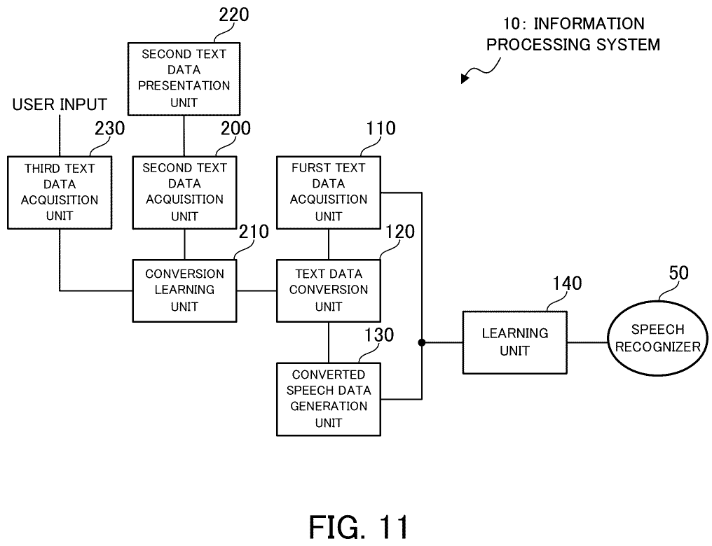

The information processing system 10 according to a sixth example embodiment will be described with reference to FIG. 11 to FIG. 13. The sixth example embodiment is partially different from the fourth and fifth example embodiments only in the configuration and operation, and may be the same as the first to fifth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the sixth example embodiment will be described with reference to FIG. 11. FIG. 11 is a block diagram illustrating the functional configuration of the information processing system according to the sixth example embodiment. In FIG. 11, the same components as those illustrated in FIG. 8 carry the same reference numerals.

As illustrated in FIG. 11, the information processing system 10 according to the sixth example embodiment includes, as components for realizing the functions thereof, the first text data acquisition unit 110, the text data conversion unit 120, the converted speech data generation unit 130, the learning unit 140, the second text data acquisition unit 200, the conversion learning unit 210, a second text data presentation unit 220, and a third text data acquisition unit 230. That is, the information processing system 10 according to the sixth example embodiment further includes the second text data presentation unit 220 and the third text data acquisition unit 230, in addition to the configuration in the fourth example embodiment already described (see FIG. 8). Each of the second text data presentation portion 220 and the third text data acquisition unit 230 may be, for example, a processing block realized or implemented by the processor 11 (see FIG. 1). The second text data presentation unit 220 may be realized or implemented including the output apparatus 16 (see FIG. 1).

The second text data presentation part 220 is configured present the second text data acquired by the second text data acquisition unit, to the user. A method of presenting the second text data by the second text data presentation unit 220 is not particularly limited. For example, the second text data display unit 220 may display the second text data to the user through a display. Alternatively, the second text data presenting unit 220 may audio-output the second text data through a speaker (i.e., may convert and output the text data into the speech data). A specific presentation method by the second text data presentation part 220 will be described in detail later.

The third text data acquisition unit 230 is configured to acquire third text data in response to an input by the user who receives presentation by the second text data presentation unit 220. The third text data acquisition unit 230 may acquire the third text data through the input apparatus 15 (see FIG. 1), for example. The third text data are text data used for the learning of the text data conversion unit 120 and are acquired as those corresponding to the second text data. For example, the third text data may be acquired as text data indicating an example of a speech error of the second text data.

### (Conversion Learning Operation)

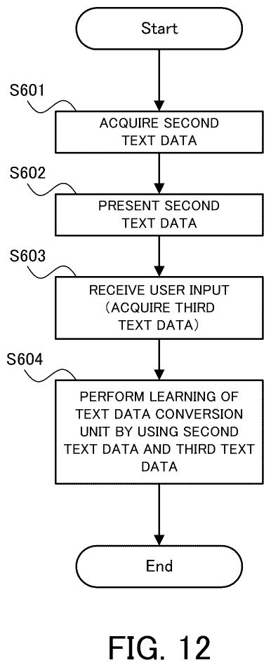

Next, a flow of the conversion learning operation in the information processing system 10 according to the sixth example embodiment will be described with reference to FIG. 12. FIG. 12 is a flowchart illustrating the flow of the conversion learning operation by the information processing system according to the sixth example embodiment.

As illustrated in FIG. 12, when the conversion learning operation of the information processing system 10 according to the sixth example embodiment is started, first, the second text data acquisition unit 200 acquires the second text data (step S601). The second text data acquired by the second text data acquisition unit 200 are outputted to each of the conversion learning unit 210 and the second text data presentation unit.

Subsequently, the second text data presentation unit 220 presents the second text data acquired by the second text data acquisition unit 200, to the user (step S602). Thereafter, the third text data acquisition unit 230 receives the user input and obtains the third text data (step S603). The third text data acquired by the third text data acquisition unit 230 are outputted to the conversion learning unit 210.

Subsequently, the conversion learning unit 210 performs the learning of the text data conversion unit 120 by using the second text data acquired by the second text data acquisition unit 200 and the third text data acquired by the third text data acquisition unit 230 (step S604). The conversion learning unit 210 may perform the learning of the text data conversion unit 120 by using only the second text data in a case where the third text data are not acquired (e.g., in a case where an input by the user is not performed).

### (Presentation Example of Second Text Data)

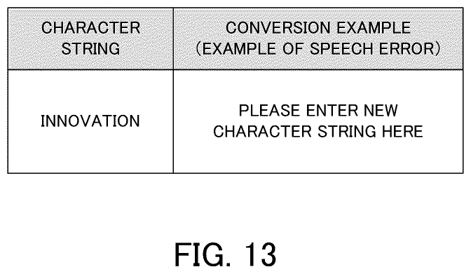

Next, with reference to FIG. 13, a method of presenting the second text data according to the second text data presentation unit 220 will be described with a specific example. FIG. 13 is a plan view illustrating a presentation example of the second text data by the information processing system according to the sixth example embodiment.

In the example illustrated in FIG. 13, the second text data are presented by using a display. Here, the second text data are displayed in a column of a character string. A column of a conversion example is displayed as a space for the user to enter the third text data. Specifically, the column of the character string displays the second text data of “innovation”. In the column of the conversion example, a message of “Please enter a new character string here” is displayed as a message for encouraging the user input. This message may be no longer displayed when the user starts the input.

In a case where the above-described presentation is performed, the user who receives the presentation enters the third text data corresponding to the second text data of “innovation”. The user may enter a plurality of third text data. For example, the user may enter “ivation,” “innoinnovation,” “innoashow,” or the like, which is a speech error example of “innovation”, as third text data.

Illustrated here is an example of displaying only one piece of second text data, but in a case where a plurality of second text data are acquired, the plurality of second text data acquired may be displayed in a list format, so as to input the third text data corresponding to each of the plurality of second text data. In addition, in a case where one piece of second text data includes a plurality of words, the plurality of words included in the second text data may be extracted, and each word may be displayed in the list format, so as to input the third text data corresponding to each word.

### (Technical Effect)

Next, a technical effect obtained by the information processing system 10 according to the sixth example embodiment will be described.

As described in FIG. 11 to FIG. 13, in the information processing system 10 according to the sixth example embodiment, the second text data are presented, and the third text data are acquired in response to the user input. Then, in the learning of the text data conversion unit 120, the third text data are used in addition to the second text data. In this way, it is possible to perform more appropriate learning, in comparison with a case where the when learning is performed by using only the second text data. For example, by using the third text data that are an example of the speech error of the second text data, the text data conversion unit 120 is allowed to generate appropriate converted text data.

### Seventh Example Embodiment

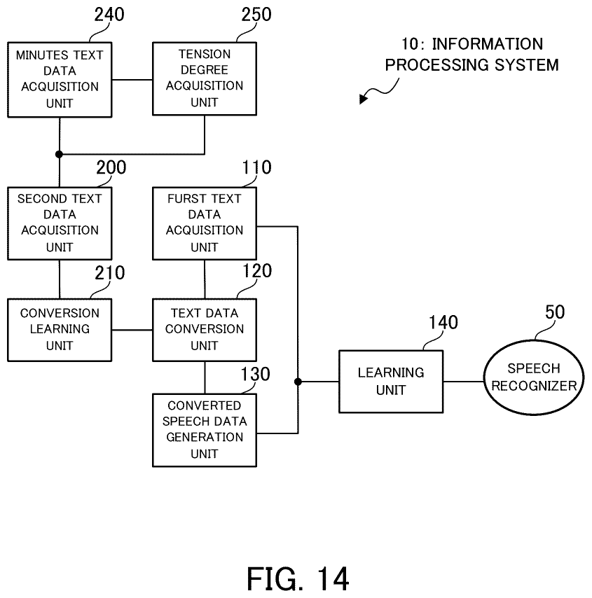

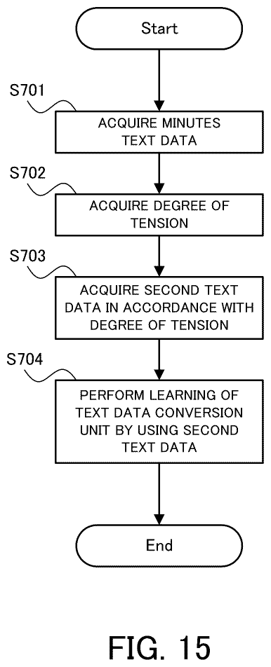

The information processing system 10 according to a seventh example embodiment will be described with reference to FIG. 14 and FIG. 15. The seventh example embodiment is partially different from the fourth to sixth example embodiments only in the configuration and operation, and may be the same as the first to sixth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the seventh example embodiment will be described with reference to FIG. 14. FIG. 14 is a block diagram illustrating the functional configuration of the information processing system according to the seventh example embodiment. In FIG. 14, the same components as those illustrated in FIG. 8 carry the same reference numerals.

As illustrated in FIG. 14, the information processing system 10 according to the seventh example embodiment includes, as components for realizing the functions thereof, the first text data acquisition unit 110, the text data conversion unit 120, the converted speech data generation unit 130, the learning unit 140, the second text data acquisition unit 200, the conversion learning unit 210, a minutes text data acquisition unit 240, and a tension degree acquisition unit 250. That is, the information processing system 10 according to the seventh example embodiment further includes the minutes text data acquisition unit 240 and the tension degree acquisition unit 250, in addition to the configuration in the fourth example embodiment already described (see FIG. 8). Each of the recording text data acquisition unit 240 and the tension degree acquisition unit 250 may be, for example, a processing block realized or implemented by the processor 11 (see FIG. 1).

The minutes text data acquisition unit 240 is configured to acquire a plurality of minutes/transcription text data. The minutes text data are data in which speech content in a meeting is converted into text. The minutes text data acquisition unit 240 may acquire the minutes text data in which the speech content is converted into text externally from the system, or may acquire the speech content (speech data) and may then convert it into text to acquire the minutes text data. The minutes text data may include information about a meeting and information about participants in the meeting. The minutes text data may include information for identifying who a speaker is. For example, the information for identifying the speaker may be associated with each sentence included in the minutes text data.

The tension degree acquisition unit 250 is configured to acquire a degree of tension in a meeting that is an origin of the minutes text data. The tension degree acquisition unit 250 may acquire the degree of tension on the basis of the minutes text data. Alternatively, the tension degree acquisition unit 250 may acquire information about the meeting separately from the minutes text data, and may acquire the degree of tension from the information. The degree of tension may be acquired, for example, on the basis of participants in the meeting. For example, a high degree of tension may be acquired for a meeting in which company executives participate, or for a meeting in which participants from another company are included. Furthermore, a low degree of tension may be acquired for a meeting in which only employees of a same department participate, or for a meeting in which only young employees participate. Alternatively, the degree of tension may be acquired in accordance with a size of the meeting. For example, a high degree of tension may be acquired for a meeting with 1000 or more participants. In addition, a low degree of tension may be acquired for a meeting with 2 or 3 participants. The degree of tension may have three stages of “low”, “medium”, “high”, or may have a finer value (e.g., a value of 1 to 100), for example.

### (Conversion Learning Operation)

Next, a flow of the conversion learning operation in the information processing system 10 according to the seventh example embodiment will be described with reference to FIG. 15. FIG. 15 is a flowchart illustrating the flow of the conversion learning operation by the information processing system according to the seventh example embodiment.

As illustrated in FIG. 15, when the conversion learning operation of the information processing system 10 according to the seventh example embodiment is started, first, the minutes text data acquisition unit 240 acquires a plurality of minutes text data (step S701). The plurality of minutes text data acquired by the minutes text data acquisition unit 240 are outputted to the tense degree acquisition unit 250. The minutes text data acquisition unit 240 may output only information about a meeting corresponding to the plurality of the meeting text data (i.e., only information used to acquire the degree of tension) to the tension degree acquisition unit 250.

Subsequently, the tension degree acquisition unit 250 acquires the degree of tension of the meeting (step S702). Information about the degree of tension acquired by the tension degree acquisition unit 250 is outputted into the second text data.

Then, the second text data acquisition unit 200 acquires the second text data on the basis of the degree of tension acquired by the tension degree acquisition unit 250 (step S703). Specifically, the second text data acquisition unit 200 acquires, as the second text data, those with the degree of tension that is higher than a predetermined value, from among the plurality of minutes text data acquired by the minutes text data acquisition unit 240. Here, the “predetermined value” is a threshold for determining whether or not the degree of tension is high enough to determine that the speech error is likely to occur, and is set in advance. The predetermined value may be configured to be properly changed by the user, for example. For example, in a case where it is desired to increase the minutes text data acquired as the second text data (i.e., it is desired to increase the number of the text data used for the learning), the predetermined value may be changed to be low. In a case where it is desired to reduce the minutes text data acquired as the second text data (i.e., it is desired to reduce the number of the text data used for the learning), the predetermined value may be changed to be high. The second text data acquired by the second text data acquisition unit 200 are outputted to the conversion learning unit 210.

Subsequently, the conversion learning unit 210 performs the learning of the text data conversion unit 120 by using the second text data (step S704). That is, the conversion learning unit 210 performs the learning of the text data conversion unit 120 by using the minutes text data in which the degree of tension is higher than the predetermined value.

### (Technical Effect)

Next, a technical effect obtained by the information processing system 10 according to the seventh example embodiment will be described.

As described in FIG. 14 and FIG. 15, in the information processing system 10 according to the seventh example embodiment, the minutes text data in which the degree of tension is higher than the predetermined value are acquired as the second text data. In this way, since the learning is performed by using the data in which the speech error is likely to occur, it is possible to perform the learning of the text data conversion unit 120, more properly.

Each of the fourth to seventh example embodiments describes the configuration for performing the learning of the text data conversion unit 120 by using the second text data, but the respective configurations of those example embodiments may be combined. That is, the configurations in the fourth example embodiment to the seventh example embodiments may be combined to perform the learning of the text data conversion unit 120.

### Eighth Example Embodiment

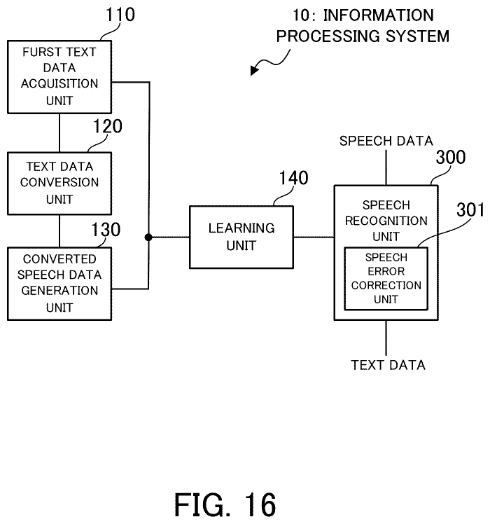

The information processing system 10 according to an eighth example embodiment will be described with reference to FIG. 16. The eighth example embodiment is partially different from the first to seventh example embodiments only in the configuration and operation, and may be the same as the first to seventh example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the eighth example embodiment will be described with reference to FIG. 16. FIG. 16 is a block diagram illustrating the functional configuration of the information processing system according to the eighth example embodiment. In FIG. 16, the same components as those illustrated in FIG. 2 carry the same reference numerals.

As illustrated in FIG. 16, the information processing system 10 according to the eighth example embodiment includes, as components for realizing the functions thereof, the first text data acquisition unit 110, the text data conversion unit 120, the converted speech data generation unit 130, the learning unit 140, and a speech recognition unit 300. That is, the information processing system 10 according to the eighth example embodiment further includes the speech recognition unit 300 in addition to the configuration in the first example embodiment already described (see FIG. 2). The speech recognition unit 300 may be, for example, a processing block realized or implemented by the processor 11 (see FIG. 1).

The speech recognition unit 300 is configured to convert and output the speech data that are inputted, into the text data. That is, the speech recognition unit 300 has the same function as that of the speech recognizer 50 described in the first to seventh example embodiments. Furthermore, the speech recognition unit 300 is configured to be learned/trained by the learning unit 140, as in the speech recognizer 50. That is, the learning/training of the speech recognition unit 300 is performed by using the first text data and the converted speech data. The speech recognizer 50 described in the first to seventh example embodiments is not included in the components of the information processing system 10, whereas the speech recognition unit 300 is included in the components of the information processing system 10. The speech recognition unit 300 includes a speech error correction unit 301.

The speech error correction unit 301 is configured to correct a speech error included in the speech data. Therefore, in a case where the speech data including the speech error are inputted to the speech recognition unit 300, the text data in which the speech error is corrected, are outputted. The speech error correction unit 301 may correct the speech error after completion of the conversion of the speech data into text, for example. That is, first, the speech data may be converted into text with the speech error included, and then, the speech error may be corrected. In addition, the speech error correction unit 301 may correct the speech error in the process of converting the speech data into text. That is, when the speech data including the speech error are inputted, the text data of a state where the speech error is corrected, may be generated.

In a case where a plurality of speech errors are included in the speech data that are inputted, the speech error correction unit 301 may correct all the speech errors, or may correct a part of the speech errors. A configuration for correcting a part of the speech errors will be described in detail in another example embodiment described later.

### (Technical Effect)

Next, a technical effect obtained by the information processing system 10 according to the eighth example embodiment will be described.

As described in FIG. 16, in the information processing system 10 according to the eighth example embodiment, a processing of correcting the speech error (or a processing of generating the text data in which the speech error is corrected) is performed in the speech recognition unit 300. In this way, even if the speech data including the speech error are inputted, it is possible to correct the speech error and to output appropriate text data (the text data that do not include the speech error).

### Ninth Example Embodiment

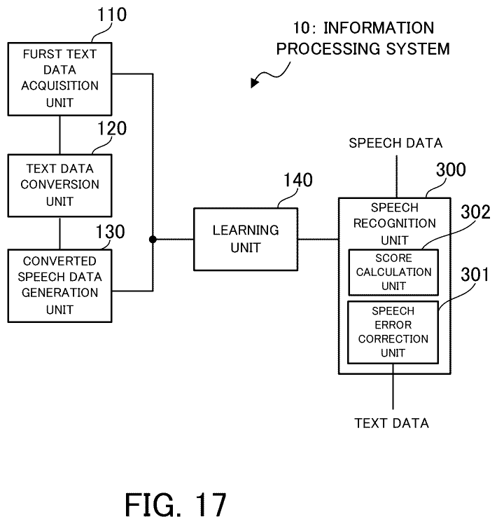

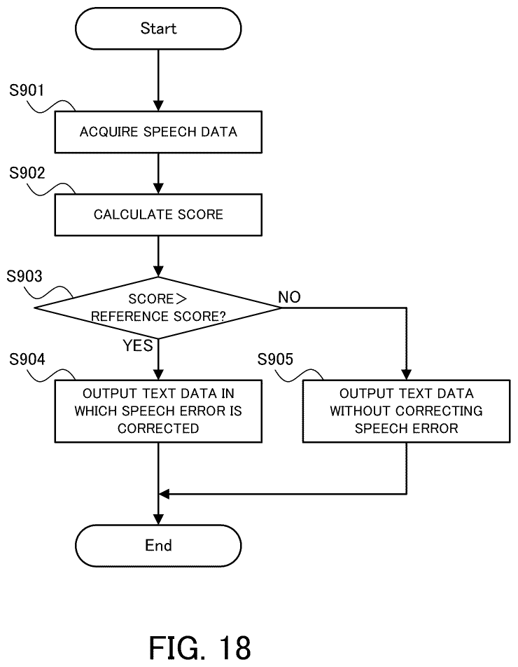

The information processing system 10 according to a ninth example embodiment will be described with reference to FIG. 17 and FIG. 18. The ninth example embodiment is partially different from the eighth example embodiment only in the configuration and operation, and may be the same as the first to eighth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the ninth example embodiment will be described with reference to FIG. 17. FIG. 17 is a block diagram illustrating the functional configuration of the information processing system according to the ninth example embodiment. In FIG. 17, the same components as those illustrated in FIG. 16 carry the same reference numerals.

As illustrated in FIG. 17, the information processing system 10 according to the ninth example embodiment includes, as components for realizing the functions thereof, the first text data acquisition unit 110, the text data conversion unit 120, the converted speech data generation unit 130, the learning unit 140, and the speech recognition unit 300. In particular, the speech recognition unit 300 according to the ninth example embodiment includes a score calculation unit 302 in addition to the speech error correction unit 301 described in the eighth example embodiment (see FIG. 16).

The score calculation unit 302 is configured to calculate a score indicating a possibility that the speech data includes a speech error. The score may be a score calculated on the basis of words included in the speech data. For example, in a case where “innovation” is mistakenly said as “ivation”, “innovation” is a word that is included in a general dictionary, but “ivation” is a word that is not included in a dictionary. In this case, it may be determined that “ivation” is likely to be a speech error of “innovation,” and a relatively high score may be calculated. On the other hand, in a case where “data” is mistakenly said as “date”, both “data” and “date” are words that are included in a general dictionary. In this case, it may be determined that “date” is less likely to be a speech error of “data”, and a relatively low score may be calculated. Furthermore, in a case where a similar word frequently appears before or after a particular word in the speech data, or in a case where there is a big difference between the number of times of appearance of the particular word and the number of times of appearance of the similar word, it may also be determined that the particular word is likely to be a speech error of the similar word. In this case, both the particular word and the similar word are words that are registered in a dictionary. For example, in a case where “data” frequently appears before or after “date”, or in a case where “date appears once, but “data” appears 20 times, it is determined that “date” is likely to be a speech error of “data.”

The speech error correction unit 301 according to the present example embodiment is configured to determine whether or not to correct the speech error, on the basis of the score calculated by the score calculation unit 302. For example, the speech error correction unit 301 may determine whether or not to correct the speech error by comparing the calculated score with a predetermined reference score. Specifically, the speech error correction unit 301 corrects the speech error when the calculated score is higher than the reference score, and may not correct the speech error when the calculated score is lower than the reference score. In addition, the speech error may be corrected when the score is high, a caution (a display to warn that there is a possibility of the speech error) may be inserted when the score is medium, and the speech error may not be corrected when the score is low. Furthermore, a degree of correction may be changed in accordance with the score. For example, a relatively large number of words may be corrected by increasing the degree of correction when the score is high, and a relatively small number of words may be corrected by reducing the degree of correction when the score is low.

### (Speech Recognition Operation)

Referring now to FIG. 18, a flow of operation when the speech data are converted into the text data (hereinafter referred to as a “speech recognition operation”) in the information processing system 10 according to the ninth example embodiment will be described. FIG. 18 is a flowchart illustrating the flow of the speech recognition operation by the information processing system according to the ninth example embodiment.

As illustrated in FIG. 18, when the speech recognition operation of the information processing system 10 according to the ninth example embodiment is started, first, the speech recognition unit 300 acquires the speech data (step S901). Then, the score calculation unit 302 calculates the score indicating the possibility that the speech data include the speech error (step S902).

Subsequently, the speech error correction unit 301 determines whether or not the score calculated by the score calculation unit 302 is higher than the reference score (step S903). When the calculated score is higher than the reference score (the step S903: YES), the speech error correction unit 301 corrects the speech error. Thus, the text data in which the speech error is corrected, are outputted (step S904). On the other hand, when the calculated score is lower than the reference score (the step S903: NO), the speech error correction unit 301 does not correct the speech error. Thus, the text data in which the speech error is not corrected, are outputted (step S905).

Illustrated here is an example of determining whether or not to correct the speech error on the basis of the reference score, but as already described, it is also possible to insert a caution or to change the degree of correction. Furthermore, whether or not to correct the speech error may be determined in word units, in sentence units, or in data units.

### (Technical Effect)

Next, a technical effect obtained by the information processing system 10 according to the ninth example embodiment will be described.

As described in FIG. 17 and FIG. 18, in the information processing system 10 according to the ninth example embodiment, it is determined whether or not to correct the speech error included in the speech data, on the basis of the calculated score. In this way, it is possible to prevent a part that is not the speech error, from being mistakenly corrected, while properly correcting the speech error.

### Tenth Example Embodiment

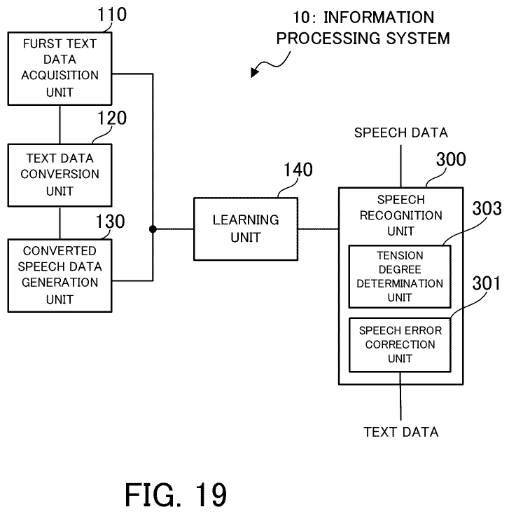

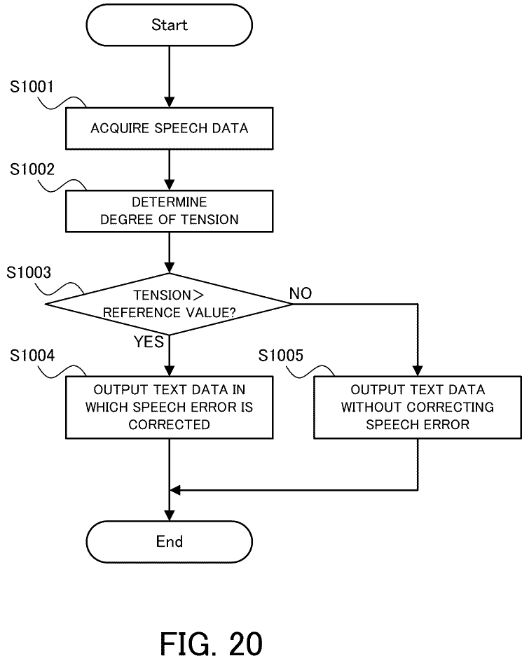

The information processing system 10 according to a tenth example embodiment will be described with reference to FIG. 19 and FIG. 20. The tenth example embodiment is partially different from the eighth and ninth example embodiments only in the configuration and operation, and may be the same as the first to eighth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the tenth example embodiment will be described with reference to FIG. 19. FIG. 19 is a block diagram illustrating the functional configuration of the information processing system according to the tenth example embodiment. In FIG. 19, the same components as those illustrated in FIG. 16 carry the same reference numerals.

As illustrated in FIG. 19, the information processing system 10 according to the tenth example embodiment includes, as components for realizing the functions thereof, the first text data acquisition unit 110, the text data conversion unit 120, the converted speech data generation unit 130, the learning unit 140, and the speech recognition unit 300. In particular, the speech recognition unit 300 according to the tenth example embodiment includes a tension degree determination unit 303 in addition to the speech error correction unit 301 described in the eighth example embodiment (see FIG. 16). Note that minutes speech data including the speech content in the meeting are assumed to be inputted to the speech recognition unit 300 according to the tenth example embodiment.

The tension degree determination unit 303 is configured to determine the degree of tension in the meeting in which the minutes speech data are recorded. The tension degree determination unit 303 may determine the degree of tension in the same manner as in the tension degree acquisition unit 250 (see FIG. 14), for example. The tension degree determination unit 303 may acquire the degree of tension, on the basis of pseudo speech data. Alternatively, the tension degree determination unit 303 may acquire information about the meeting separately from the minutes speech data, and may acquire the degree of tension from the information. The degree of tension may be acquired in accordance with participants in the meeting, a size of the meeting, or the like, for example.

The speech error correction unit 301 according to the present example embodiment is configured to determine whether or not to correct the speech error, on the basis of the degree of tension determined by the tension degree determination unit 303. For example, the speech error correction unit 301 may determine whether or not to correct the speech error by comparing the determined degree of tension with a predetermined reference value. Specifically, the speech error correction unit 301 may correct the speech error when the determined degree of tension is higher than the reference value, and may not correct the speech error when the determined degree of tension is lower than the reference value. In addition, the speech error may be corrected when the degree of tension is high, a caution (a display to warn that there is a possibility of the speech error) may be inserted when the degree of tension is medium, and the speech error may not be corrected when the degree of tension is low. Furthermore, the degree of correction may be changed in accordance with the degree of tension. For example, a relatively large number of words may be corrected by increasing the degree of correction when the degree of tension is high, and a relatively small number of words may be corrected by reducing the degree of correction when the degree of tension is low.

### (Speech Recognition Operation)

Referring now to FIG. 20, a flow of an operation when the speech data are converted into the text data (hereinafter referred to as a “speech recognition operation” as appropriate) in the information processing system 10 according to the tenth example embodiment will be described. FIG. 20 is a flowchart illustrating the flow of the speech recognition operation by the information processing system according to the tenth example embodiment.

As illustrated in FIG. 20, when the speech recognition operation of the information processing system 10 according to the tenth example embodiment is started, first, the speech recognition unit 300 acquires the speech data (the minutes speech data) (step S1001). Then, the tension degree determination unit 303 determines the degree of tension in the meeting in which the minutes speech data are recorded (step S1002).

Subsequently, the speech error correction unit 301 determines whether or not the degree of tension determined by the tension determination unit 303 is higher than the reference value (step S1003). When the determined degree of tension is higher than the reference value (the step S1003: YES), the speech error correction unit 301 corrects the speech error. Thus, the text data in which the speech error is corrected, are outputted (step S1004). On the other hand, when the determined degree of tension is lower than the reference value (the step S1003: NO), the speech error correction unit 301 does not correct the speech error. Thus, the text data in which the speech error is not corrected, are outputted (step S1005).

Illustrated here is an example of determining whether or not to correct the speech error on the basis of the reference value, but as already described, it is also possible to insert a caution or to change the degree of correction. Furthermore, whether or not to correct the speech error may be determined in word units, in sentence units, or in data units.

### (Technical Effect)

Next, a technical effect obtained by the information processing system 10 according to the tenth example embodiment will be described.

As described in FIG. 19 and FIG. 20, in the information processing system 10 according to the ninth example embodiment, it is determined whether or not to correct the speech error included in the speech data, on the basis of the degree of tension in the meeting. In this way, it is possible to prevent a part that is not the speech error, from being mistakenly corrected, while properly correcting the speech error.

Each of the eighth to tenth example embodiments describes the configuration in which the information processing system 10 includes the speech recognition unit 300, but the respective configurations of those example embodiments may be combined. That is, the configurations in the eighth example embodiment to the tenth example embodiment may be combined to realize the speech recognition unit 300 that performs the speech recognition operation.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing system according to Supplementary Note 1 is an information processing system including: a first text data acquisition unit that acquires first text data: a text data conversion unit that converts the first text data, thereby to generate converted text data; a converted speech data generation unit that generates converted speech data corresponding to the converted text data; and a learning unit that performs learning of a speech recognition unit that generates, from speech data, text data corresponding to the speech data, by using the first text data and the converted speech data as inputs.

### (Supplementary Note 2)

An information processing system according to Supplementary Note 2 is the information processing system according to Supplementary Note 1, further including a first speech data generation unit that generates first speech data corresponding to the first text data, wherein the learning unit performs the learning of the speech recognition unit by using the first text data, the converted speech data, and the first speech data, as inputs.

### (Supplementary Note 3)

An information processing system according to Supplementary Note 3 is the information processing system according to Supplementary Note 1 or 2, wherein the text data conversion unit stores at least one conversion rule, and generates the converted text data on the basis of the conversion rule.

### (Supplementary Note 4)

An information processing system according to Supplementary Note 4 is the information processing system according to any one of Supplementary Notes 1 to 3, further including: a second text data acquisition unit that acquires second text data; and a conversion learning unit that performs learning of the text data conversion unit by using the second text data.

### (Supplementary Note 5)

An information processing system according to Supplementary Note 5 is the information processing system according to Supplementary Note 4, wherein in a case where a first word and a second word, which are similar to each other, are included in a predetermined range in the second text data, the conversion learning unit determines that one of the first word and the second word is a speech error of the other, and performs the learning of the text data conversion unit.

### (Supplementary Note 6)

An information processing system according to Supplementary Note 6 is the information processing system according to Supplementary Note 4 or 5, further including: a presentation unit that presents the second text data to a user; and a third text data acquisition unit that acquires third text data corresponding to the second text data in accordance with an operation by the user who receives presentation by the present unit, wherein the conversion learning unit performs the learning of the text data conversion unit by using the second text data and the third text data.

### (Supplementary Note 7)

An information processing system according to Supplementary Note 7 is the information processing system according to any one of Supplementary Notes 4 to 6, further including: a minutes text data acquisition unit that acquires a plurality of minutes text data in which speech content in a meeting is converted into text; and a tension degree acquisition unit that acquires a degree of tension in the meeting, wherein the second text data acquisition unit acquires, as the second text data, those with the degree of tension that is higher than a predetermined value, from among the plurality of minutes text data.

### (Supplementary Note 8)

An information processing system according to Supplementary Note 8 is the information processing system according to any one of Supplementary Notes 1 to 7, further including the speech recognition unit, wherein the speech recognition unit outputs the text data in which a speech error in the speech data is corrected on the basis of a learning result by the learning unit.

### (Supplementary Note 9)

An information processing system according to Supplementary Note 9 is the information processing system according to Supplementary Note 8, wherein the speech recognition unit calculates a score indicating a possibility that the speech data includes the speech error, and determines whether or not to correct the speech error in the speech data, on the basis of the score.

### (Supplementary Note 10)

An information processing system according to Supplementary Note 10 is the information processing system according to Supplementary Note 8 or 9, wherein the speech data are minutes speech data including speech content in a meeting, and the speech recognition unit determines a degree of tension in the meeting, and determines whether or not to correct the speech error in the speech data, on the basis of the degree of tension.

### (Supplementary Note 11)

An information processing apparatus according to Supplementary Note 11 is an information processing apparatus including: a first text data acquisition unit that acquires first text data: a text data conversion unit that converts the first text data, thereby to generate converted text data; a converted speech data generation unit that generates converted speech data corresponding to the converted text data; and a learning unit that performs learning of a speech recognition unit that generates, from speech data, text data corresponding to the speech data, by using the first text data and the converted speech data as inputs.

### (Supplementary Note 12)

An information processing method according to Supplementary Note 12 is an information processing method executed by at least one computer, the information processing method including: acquiring first text data; converting the first text data, thereby to generate converted text data; generating converted speech data corresponding to the converted text data; and performing learning of a speech recognition unit that generates, from speech data, text data corresponding to the speech data, by using the first text data and the converted speech data as inputs.

### (Supplementary Note 13)

A recording medium according to Supplementary Note 13 is a recording medium on which a computer program that allows at least one computer to execute an information processing method is recorded, the information processing method including: acquiring first text data; converting the first text data, thereby to generate converted text data; generating converted speech data corresponding to the converted text data; and performing learning of a speech recognition unit that generates, from speech data, text data corresponding to the speech data, by using the first text data and the converted speech data as inputs.

### (Supplementary Note 14)

A computer program according to Supplementary Note 14 is a computer program that allows at least one computer to execute an information processing method, the information processing method including: acquiring first text data; converting the first text data, thereby to generate converted text data; generating converted speech data corresponding to the converted text data; and performing learning of a speech recognition unit that generates, from speech data, text data corresponding to the speech data, by using the first text data and the converted speech data as inputs.

This disclosure is allowed to be changed, if desired, without departing from the essence or spirit of this disclosure which can be read from the claims and the entire specification. An information processing system, an information processing apparatus, an information processing method, and a recording medium with such changes are also intended to be within the technical scope of this disclosure.

### DESCRIPTION OF REFERENCE CODES

10 Information processing system
11 Processor
14 Storage apparatus
50 Speech recognizer
110 First text data acquisition unit
120 Text data conversion unit
121 Conversion rule storage unit
130 Converted speech data generation unit
140 Learning unit
150 First speech data generation unit
200 Second text data acquisition unit
210 Conversion learning unit
211 Similar word detection unit
220 Second text data presentation unit
230 Third text data acquisition unit
240 Minutes text data acquisition unit
250 Tension degree acquisition unit
300 Speech recognizer
301 Speech error correction unit
302 Score calculation unit
303 Tension degree determination unit

What is claimed is:

1. An information processing system comprising:
at least one memory that is configured to store instructions; and
at least one processor that is configured to execute the instructions to require first text data:
convert the first text data, thereby to generate converted text data;
generate converted speech data corresponding to the converted text data; and
perform learning of a speech recognition unit that generates, from speech data, text data corresponding to the speech data, by using the first text data and the converted speech data as inputs.

2. The information processing system according to claim 1, wherein the at least one processor is configured to execute the instructions to:
generate first speech data corresponding to the first text data, and
perform the learning of the speech recognition unit by using the first text data, the converted speech data, and the first speech data, as inputs.

3. The information processing system according to claim 1, wherein the at least one processor is configured to execute the instructions to store at least one conversion rule, and generate the converted text data on the basis of the conversion rule.

4. The information processing system according to claim 1, wherein the at least one processor is configured to execute the instructions to:
convert the first text data to generate the converted text data by a text data conversion unit;
acquire second text data; and
perform learning of the text data conversion unit by using the second text data.

5. The information processing system according to claim 4, wherein in a case where a first word and a second word, which are similar to each other, are included in a predetermined range in the second text data, the at least one processor is configured to execute the instructions to determine that one of the first word and the second word is a speech error of the other, and perform the learning of the text data conversion unit.

6. The information processing system according to claim 4, wherein the at least one processor is configured to execute the instructions to:
present the second text data to a user; and
acquire third text data corresponding to the second text data in accordance with an operation by the user who receives presentation, and
perform the learning of the text data conversion unit by using the second text data and the third text data.

7. The information processing system according to claim 4, wherein the at least one processor is configured to execute the instructions to:
acquire a plurality of minutes text data in which speech content in a meeting is converted into text;
acquire a degree of tension in the meeting, and
acquire, as the second text data, those with the degree of tension that is higher than a predetermined value, from among the plurality of minutes text data.

8. The information processing system according to claim 1, wherein the at least one processor is configured to execute the instructions to output the text data in which a speech error in the speech data is corrected on the basis of a learning result.

9. The information processing system according to claim 8, wherein the at least one processor is configured to execute the instructions to calculate a score indicating a possibility that the speech data includes the speech error, and determine whether or not to correct the speech error in the speech data, on the basis of the score.

10. The information processing system according to claim 8, wherein
the speech data are minutes speech data including speech content in a meeting, and
the at least one processor is configured to execute the instructions to determine a degree of tension in the meeting, and determine whether or not to correct the speech error in the speech data, on the basis of the degree of tension.

11. (canceled)

12. An information processing method executed by at least one computer, the information processing method comprising:
acquiring first text data;
converting the first text data, thereby to generate converted text data;
generating converted speech data corresponding to the converted text data; and
performing learning of a speech recognition unit that generates, from speech data, text data corresponding to the speech data, by using the first text data and the converted speech data as inputs.

13. A non-transitory recording medium on which a computer program that allows at least one computer to execute an information processing method is recorded, the information processing method including:
acquiring first text data;
converting the first text data, thereby to generate converted text data;
generating converted speech data corresponding to the converted text data; and
performing learning of a speech recognition unit that generates, from speech data, text data corresponding to the speech data, by using the first text data and the converted speech data as inputs.
